(19) United States
(12) Patent Application Publication
(10) Pub. No.: US 2014/0042296 A1
(43) Pub. Date: Feb. 13, 2014

(54) Heliostat with a Drive Shaft Pointing at the Target, Reflection Sensor and a Closed-Loop Control System

(71) Applicants: Julian Lopez Garrido, Sevilla (ES); Emilio Murcia Pacheco, Sevilla (ES); Daniel Inesta Gonzalez, Sevilla (ES); Pedro Jose Murcia Pacheco, Sevilla (ES)

(72) Inventors: Julian Lopez Garrido, Sevilla (ES); Emilio Murcia Pacheco, Sevilla (ES); Daniel Inesta Gonzalez, Sevilla (ES); Pedro Jose Murcia Pacheco, Sevilla (ES)

(73) Assignee: Aplicaciones Renovables Integradas, S.L., Sevilla (ES)

(21) Appl. No.: 14/002,834

(22) PCT Filed: Mar. 3, 2011
(86) PCT No.: PCT/ES2011/070137

§ 371 Date: Oct. 29, 2013

(51) Int. Cl. G01J 1/42

(52) U.S. Cl. CPC G01J 1/4228
USPC 250/203.4

(57) ABSTRACT

Heliostat comprising a drive shaft pointing at the target, two reflection or refraction solar sensors, and a closed-loop control system, independent of the solution provided by the main reflective optics. The first solar sensor (14) detects the position of the incident main beam (22) with respect to the main plane of the optics (21), while the second solar sensor (15) detects the position of the reflected main beam (23) with respect to the drive plane (10). The closed-loop control system is retroactively supplied by the signals from these two sensors that compare said signals at all times, and coordinates the primary drive (4) and the secondary drive (6) in order to achieve the condition of pointing at the target at all times.

### OBJECT OF THE INVENTION

The present invention relates to a heliostat belonging to a solar field which reflects the light beams that reach it, provided with a solar tracking mechanism. It is an invention that belongs, within the area of the heat engineering, to the field of the production of energy from solar radiation.

This invention does not consider the typology or nature of the main reflective surface that supports it, so that this surface could be flat, spherical, parabolic, cylindrical, thoroidal, checkered, or adopt any other geometric configuration.

This invention does not specify the defined structural implementation of the system, but it encompasses all structural implementations which satisfy the conditions of movement and operation.

### BACKGROUND OF THE INVENTION

The use of solar energy as an energy source is carried out by man since ancient times. The Sun emits a huge amount of energy, a part of which comes to Earth in the form of light and heat. Since the mid-20th century investigations are being conducted to try to transform that energy into electricity: thus, there have been developed photovoltaic panels that produce directly electricity when its surface is conveniently activated by light, and different types of heat collectors which concentrating beams of light on a pipe or a central receiver containing a fluid, reach sufficient temperatures to produce large quantities of steam which generates electricity through a turbine, normally in a Rankine cycle. This last type of installation is the subject matter of the present invention.

Given the low specific power per unit area of solar radiation, in order to make good use of this energy, it is necessary to concentrate a large number of light beams on a single point, what is traditionally carried out by means of mirrors focused on a tank or pipe by way of a collector. In this case the radiation is by indirect concentration, since the beams previously have to rebound in the mirror to reach their target.

The state of the art has different patented systems internationally designed to optimize the concentration and use of solar energy reflected by systems of heliostats for the production of electric power as well as accessories and complements that are reflected in different entries of the International Patent Classification.

The solution adopted by the patent publication number ES 8100499, is the so-called classical solution with vertical or zenith axis. This mechanical solution requires an extremely accurate and complex control and drive and an initial calibration to maintain the pointing for a short period of time until the next calibration. The astigmatic aberration (unwanted phenomenon of all lenses when looking obliquely through them, in this case deformation of the reflected image of the Sun) tends to increase the apparent size of the Sun outside the optimal operating conditions. Given that the objective is to obtain an image of the Sun as small as possible (concentration of received energy), this phenomenon is unwanted. The present invention solves both inconveniences since the closed-loop control system eliminates the need for continuous re-calibration, and constructively, the astigmatic aberration is minimal in spin-elevation drive systems.

Another patent with publication number ES 2244339 proposes a constructive solution different from the classical configuration. This, like the previous one, also has an open-loop control system conditioned to a great number of recalibrations of the system that, as noted, the present invention solves by adding the advantage of reducing costs in both the tracking system and maintenance system.

The first heliostats considered as industrial elements were developed at the beginning of the 1980s for the experimental solar thermal power plants with central receiver, with the purpose of testing the viability of solar thermal energy in the processes of electricity production on an industrial scale. Table 1 summarizes the projects performed because of the international initiative (Data, Name of the Facility, Year of installation, Location, electric power (MWe), Type of heliostats installed, Number of heliostats and m²):

| Name | Year | Location | MWe | Type | No./m² |
|---|---|---|---|---|---|
| SSPS- | 1981 | Almeria | 0.5 | Martin-Marietta | 93/3655 |
| CRS | | | | | |
| Eurelios | 1981 | Andrajo | 0.7 | | 182/6216 |
| Sunshine | 1981 | Nio | 0.8 | | 807/12912 |
| Themis | 1982 | Targassone | 2.5 | | 201/10800 |
| Solar | 1982 | Barstow | 10 | Martin-Marietta | 1818/71447 |
| ONE | | | | | |
| CESA-1 | 1983 | Almeria | 1 | CASA y SENER | 300/11880 |
| SPP-5 | 1985 | Crimen | 5 | | 1600/40000 |
| WISS | 1988- | Rehovot | 3 | ASINEL | |

Once finished the demonstration projects, most of these plants were shut down. In USA the Solar One plant was remodeled, and with the same field of heliostats, the Solar Two plant put into operation which has been running until April 1999.

In Europe only continued in service the fields of heliostats corresponding to the plants CRS and CESA-1, thanks to a collaboration agreement between the German and Spanish Governments, constituting the Plataforma Solar de Almeria (PSA).

The PSA is currently continues to operate these fields of heliostats thanks to a great diversity of projects that have been carried out over the past years. The aim of these projects has been the development and evaluation of new solar components in this technology, mainly heliostats and solar receivers.

None of the heliostats developed and applied in these plants is similar to the one presented here, since all these are based on an azimuth-altitude tracking mechanism, while the one presented is based on a rotation mechanism around the axis of pointing and elevation.

The azimuth-altitude system consists of a vertical rotating axis (constant) and other horizontal-rotating axis (which rotates with the first). This assembly involves problems related to the optics in reflection, decreasing the concentration of beams reflected by the system and therefore the total efficiency of the solar plant.

The essential difference of the invention is the configuration of the axes of rotation, which allows, on the other hand, introducing the closed-loop control system.

The invention described below has been developed after numerous studies and tests, and after the understanding of the possibilities of optimization of several solutions previously discussed by various research teams.

The general objective sought with the present invention is the development of a device with a cost-effective installation, which minimizes maintenance costs, makes the most of the solar radiation and is quick and easy to install in any location.

### DESCRIPTION OF THE INVENTION

The existing devices the mission of which is to reflect the energy from the Sun toward a target have two main problems:

The control system is an open-loop system, since due to the construction, these devices are unable to get a signal indicating the extent to which are approaching or are moving away from the desired operational state. This results in costly control systems besides a reduction of precision.

The reflected energy varies greatly the way of impact in the target over time. Since the angle with which the Sun is reflected in the heliostat varies greatly, this affects the optics of reflection by varying the way in which the reflected energy affects the target over time, with the probability of doubling the size of the incidence region of the reflected beams.

The invention that aims to meet the intended purposes and solve these problems, consists of a device formed by a heliostat that reflects the solar radiation with less astigmatic error (a phenomenon explained above) depending on the time, and operation of which is carried out in a different configuration from those existing, with closed-loop control system.

All this is possible because the kinematics of the system is substantially different to that of the previous devices.

As in these devices, the system consists of two orthogonal turns along two separate axes of rotation of which one of them, the primary axis, is fixed in space and the other, the secondary axis, varies its position depending on the rotation around the primary axis.

On the contrary, in the proposed invention the primary axis remains pointing at the target at all times, and therefore the primary axis contains the target. This configuration is called pointing at the target. The plane formed by the primary axis and the Sun will be the reflection plane, because this plane reflects solar energy to the target. The secondary axis will be the axis perpendicular to the reflection plane.

This geometric condition, in which the plane perpendicular to the secondary axis must contain the Sun and therefore the beams from the Sun are perpendicular to the secondary axis, is that provides the possibility of decreasing the astigmatic error. How to do it falls within the scope of application referred to the reflective surface, and since this is beyond the scope of this patent will be omitted.

Geometric condition highlighted in the previous paragraph is also used to obtain the first of the two signals which allow the closed-loop control system. To this end, a pointer or solar sensor is placed on the outer end of the reflective surface, and contained in the plane perpendicular to the secondary axis. This solar sensor provides a signal that indicates if the Sun is located on one side or the other of the plane perpendicular to the secondary axis. This signal allows knowing if the rotation of the primary axis is appropriate to reflect the solar energy in the target.

The ultimate purpose of the invention is to reflect the energy towards the target, which means that the reflected energy is moved towards the target according to the direction of the primary axis. This means that the beam—First condition or condition 1: the plane perpendicular to the secondary axis has to perpendicular, that geometrically indicates that this direction is that of the straight line formed by the intersection of both planes.

The first presented sensor checks the first of these two conditions. The second condition is that the reflected main beam is contained in the plane formed by the primary axis and the secondary axis. The plane formed by the primary axis and the secondary axis is the drive plane.

There are two methods to check that the second condition is met:

Direct measurement: A sensor is positioned in the path of the energy reflected to the target. A small amount of energy from that intended to reach the receiver to verify that it points correctly is intercepted.

Indirect measurement: A small amount of energy from the intended to reach the receiver opposite and parallel to its direction of travel through an optical system is deflected. This energy is that is checked by the sensor.

There are two types of optical system:

Reflexive: It reflects the incident energy by a secondary reflective surface that forms 90° with the reflective surface of the heliostat. By basic geometry, the angle formed by the main directions of energy reflected by the main reflection system and this secondary system is 180°. This system is shown in FIG. 10.

Holographic: It captures part of the incident energy through a surface with a special optical treatment which forms behind a virtual image of the Sun that indicates when the reflected energy reaches to the receiver or if the system is not correctly aligned.

To complete the system of measurement on the primary axis, after the optical system, is placed a sensor like the one that monitors the first condition and with its reference plane parallel to that formed by the primary axis and the secondary axis.

The whole of the elements described and the strategy for movement and control make up the invention object of this document.

For a better understanding of that set forth here in the following section all the terms used are clarified and illustrated by images.

### DESCRIPTION OF THE DRAWINGS

First of all a series of terms are listed and developed, with the meaning described, and that are represented in a series of figures.
Solar energy: Radiant energy coming from the Sun and reaches the Earth's surface with characteristic intensity and spectral composition.
Heliostat: Mirror of great focal length, equipped with movement in two axes and the mission of which is to reflect, concentrate and maintain static the image of the Sun in a particular focus throughout the day.
Field of heliostats: It also knows as primary concentrator or solar field, it is a set of heliostats arranged in an enclosed field and mission of which is the contribution of radiant energy to a target or receiver.
Solar receiver or target: Device that intercepts and absorbs solar radiation provided by a field of heliostats in order to transfer it through a heat exchanger to power plant block.
Solar thermal power plant with central receiver: Electric energy production plant which bases its operating strategy in the provision of heat to a certain conventional thermodynamic cycle, through the concentration of solar radiation by a large number of heliostats on a single receiver.
Incident main beam: That coming from the center of the solar disk and cuts into the center of the heliostat optics.
Reflected main beam: That coming from the middle focal point of the heliostat optics and results from the reflection of the beam main incident on the heliostat.
Solar sensor or solar pointer: Device that is capable of discriminating the position of the Sun using optical, photovoltaic, thermal phenomena or otherwise with respect to a reference plane, allowing to know if the Sun is on one side or another of the same, generally with the aim of matching this reference plane with the position of the Sun (condition of pointing).
Optical system: Device installed on the heliostat which aims to deflect a small fraction of the incident energy so that it will be possible to monitor by this, and using a solar sensor, the incidence of the rest of energy reflected in the target or solar receiver.
First condition or condition 1: The plane perpendicular to the secondary axis must contain the Sun. It is one of the two geometric conditions that lead to the reflected main beam is directed properly towards the target, and in the proposed invention is achieved by a proper rotation of the primary axis.
Sensor of condition 1 or sensor 1: Solar sensor that reports the compliance with the condition 1.
Second condition or condition 2: It can be stated as “the reflected main beam is contained in the plane formed by the primary and secondary axes”. It is one of the two geometric conditions that lead to the correct reflection of the main beam toward the target, and in the proposed invention is achieved by a proper rotation of the secondary axis.
Sensor of condition 2 or sensor 2: Solar sensor that reports the compliance with the condition 2.
Incident secondary beam: That coming from the center of the solar disk and cuts into the center of the optical system.
Deflected main beam: That coming from the central point of the optical system and results from the reflection of the incident secondary beam.
Reflection plane: That containing the incident main beam and the reflected main beam.
Primary axis: Axis of rotation of the heliostat that remains fixed in space during its operation and with regard to which rotates the mobile assembly.
Main plane of the optics: Plane of symmetry of the reflective surface, which in turn contains the primary axis.
Secondary axis: Axis of rotation of the heliostat that is orthogonal to the primary axis, and to the main plane of the optics.
Optical axis of a heliostat: Virtual straight line that passes through the center of the optics, cuts orthogonally to the secondary axis of the heliostat and is contained in the main plane of the optics.
Drive plane: Plane containing the primary axis and the secondary axis.
Horizontal mount: Mechanical device with two-axis orientation of a heliostat with respect to a topocentric system of horizontal coordinates, called azimuth and altitude. The fundamental plane is the horizon of the observer and the fundamental point is the true North. The orientation of the heliostat, depending on the daytime evolution of the Sun in this coordinate system, is achieved by azimuth rotation (arches of the horizon from the fundamental point), and altitude or zenith rotation (arches orthogonal to the horizon plane in the direction of the observer's zenith). The mechanical axis of azimuth rotation is orthogonal to the plane of the horizon and fixed orientation. On the contrary, the axis of zenithal rotation is parallel to the plane of the horizon with variable orientation, due to the existence of a mechanical ligature between the movements, causing the “dragging” of the zenith axis every time that the azimuth rotation occurs.
Spin-elevation mount: Mechanical device constructively similar to the horizontal mount but primary axis of which is not vertical but is oriented in such a way that said axis points at the target or the solar receiver. The system of axes in this case is also orthogonal, which means that the secondary axis remains perpendicular to the primary at all times. The orientation of the heliostat depending on the daytime evolution of the Sun is achieved by rotations around the primary axis and inclination with respect to the pointing axis.
Facets: Individual mirror elements of which the reflective surface of some heliostats is made.
Declination: Change of the height of the Sun on the celestial equator when the Earth, throughout the year, travels its pathway (ecliptic) around the Sun.
Pointing strategy: Operating method of a solar thermal power plant consisting of defining a set of coordinates on the receiver to where each of the heliostats of the field must point to achieve the energy distribution required on this.
Dynamic pointing strategy: It is a pointing strategy in which the coordinates on the receiver change over time following certain control criteria.

In order to complete the description below and help to a better understanding of the characteristics of the invention, a detailed description of a preferred preparation based on a set of drawings that accompany this specification will be now carried out, and where the following has been represented simply with orientative and non-limitative character:

FIG. 1 shows a solar thermal power plant with central receiver where the heliostat of the invention can be used. There can also be seen the main elements of the plant as the tower (13) where the receiver (11) is located, the heliostats and other attached facilities.

FIG. 2 shows a rear perspective view of a “horizontal” mount of a heliostat. In this figure there can be seen the zenith axis (9), which in this case corresponds with the primary axis (3), and the secondary axis (5) in this case horizontal. This configuration is the most common monopole configuration where the structure is supported by a pedestal (7), where it can also be seen an element common to all heliostat, the control device (8).

FIG. 3 shows a rear perspective view of a “spin-elevation” mount of a variant of the heliostat of invention. This configuration is more similar to the configuration of “horizontal” mount. The way of supporting the weight of the structure is by a pedestal (7), and also consists of device control (8). In this mount, the primary axis (3) varies its inclination and orientation with respect to the position relative to the target (11). The secondary axis (5), which in the position represented is in a horizontal position, varies its position in a plane perpendicular to the primary axis (3). In the figure it can also be seen the rotating points on which the inclination and orientation of the primary axis is regulated, in the attachment mechanism of the pedestal (7) and the primary axis (3).

FIG. 4 shows a perspective of the heliostat object of the invention, in a general configuration. Note that in this figure, the primary axis (3) and the secondary axis (5), and a way to drive them through the primary drive (4) and the secondary drive (6) can clearly be seen. It is also represented the control system (8), common to all heliostat. The optical system (17) is located in the center of the reflective surface ahead of the sensor of condition 2 (15) which along with the sensor of condition 1 (14) shown in the following figure, make up the reuptake system required for the closed-loop control system.

FIG. 5 shows a side view and another front view of the heliostat. In this figure, apart from the outstanding elements in the previous figure, such as the primary axis (3), primary drive (4), secondary axis (5), secondary drive (6) and the control system (8), other elements can be seen. The reflective surface (1) is mounted on the mobile support (2), and on this support, the sensor of condition 1 (14) is located at the end.

FIG. 6 shows a plan view of the reflection plane. In this view it can be seen the main characteristics of the solar energy reflection in a correct pointing position. The reflective surface (1) orients itself according to the optical axis (18). The incident main beam (22) and the reflected main beam (23) form both an angle at all times and with the optical axis (18) direct consequence of the law of reflection. The reflected main beam (23) results from the reflection of the incident main beam (22) from the Sun (12), and it is reflected by the reflective surface (1), and so that it reaches the target (11), located in the tower (13), this must be coincident with the main shaft (3), for what the system is activated by the primary axis (3) and the secondary axis (5). Although it is not represented in this figure, both the main plane of the optics (21) and the reference plane of the sensor of condition 1 will be located in the reflection plane to meet the condition 1.

FIG. 7 shows, schematically in perspective, the spatial geometry on which the invention is based. In this configuration, the two pointing conditions that allow the reflected main beam (23) reaching the target (11) are being met. This representation explains the participation of some elements that do not appear in the previous figure, as the drive plane (10).

FIG. 8 is a top view of FIG. 6. This figure together with the previous two just clarifying the spatial position of all the elements involved in the reflection.

FIG. 9 represents the detail of a possible configuration of sensor 1 (14). This sensor consists of an opaque surface (24) as a physical representation of the reference plane and two sensitive surfaces (25) to the incident solar energy. The sensitive surface (25) on the side where the Sun (12) is, will produce a greater signal (it can be seen the dotted part where the sensitive surface does not illuminate), which indicates a failure to comply with the condition 1. At the time that the Sun (12) is contained in the reference plane, the sensitive surfaces (25) will generate the same signal and the correct position with respect to the rotation of the main shaft will be known.

FIG. 10 represents the detail of a possible configuration of the optical system (17) of the sensor 2 (15). In this case, the sensor 2 (15) is equal to the sensor 1 (14), except that only varies its position by the action of the primary axis (3), remaining the opaque surface (24) parallel to this axis at all times. The opaque surface (24) also remains parallel to the secondary axis (5), so said surface is located in the drive plane (10), which is perpendicular to the main plane of the optics (21) that is the plane to which the opaque surface (24) of the sensor 1 (14) is parallel. The secondary reflective surface (26) rotates around the secondary axis (5) reorienting the deflected main beam towards the sensor 2 (15). By the same phenomenon that in the sensor 1 (14), when the sensitive surfaces produce the same signal, the deflected main beam (19) will be parallel to the primary axis (3) and therefore the reflected main beam (23) will also be parallel to the axis and therefore it will be directed to the target (11).

FIG. 11 shows a view of the reflection plane, once the condition 1 is met, and therefore both the Sun and the objective are in the reflection plane. In this figure it can be seen the arrangement of sensor 2 (15) and its optical system (17) when the rotation around the secondary axis (5) leads to the fulfillment of the condition 2. It is important to emphasize here that the drive of the rotation around the secondary axis (5) changes the orientation in the plane of the figure of all the elements of the heliostat represented with the exception of the sensor 2 (15). This is because the sensor 2 (15) is located or attached to the T-shape piece that articulates the movement according to the secondary axis (5), and therefore does not experience movement around this axis.

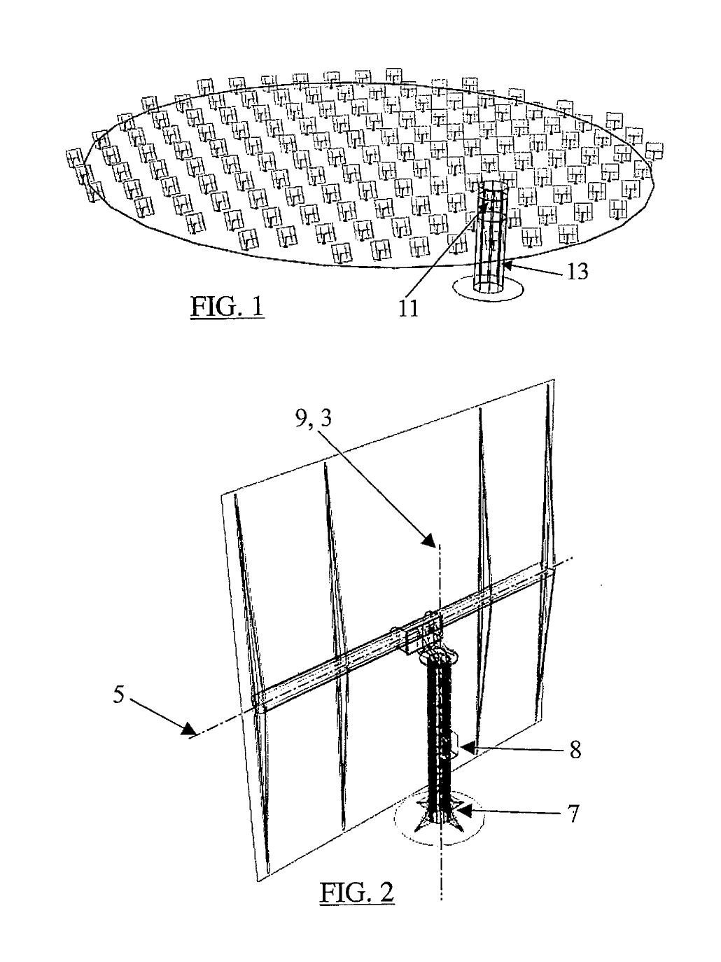

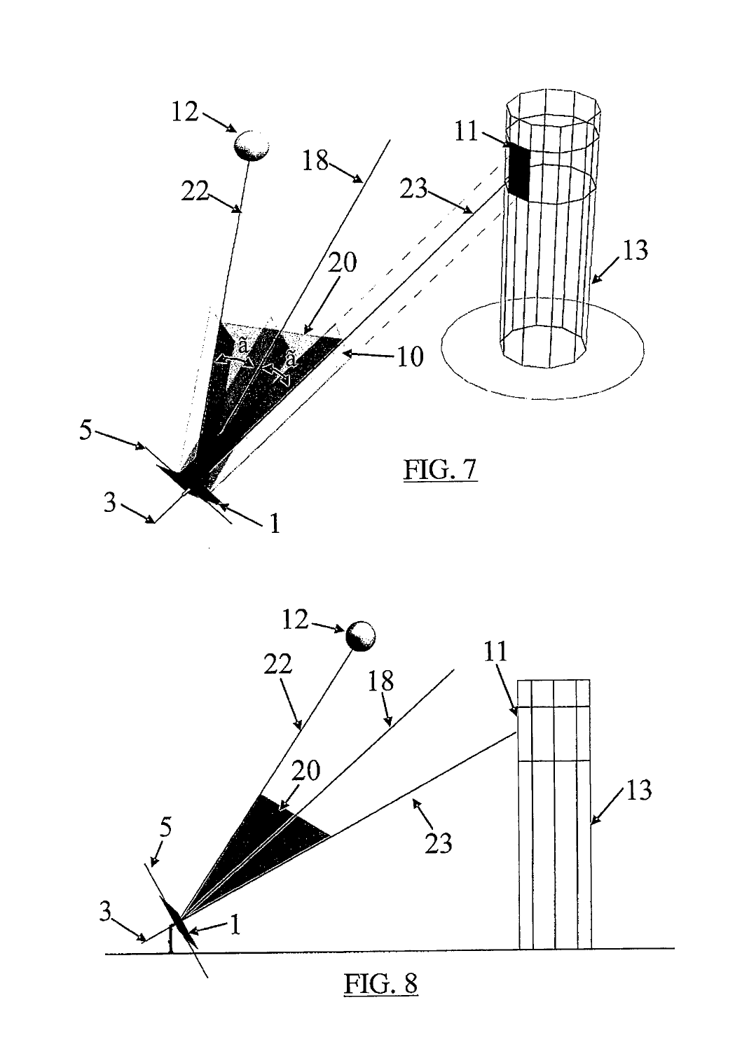

Noted that the FIGS. 1 to 3 correspond to the field of application of the invention, prior art and necessity of the invention, FIGS. 4 to 6 correspond to the structural description of the invention, FIGS. 7 and 8 correspond to the explanation of the operating mode of the invention, while the FIGS. 9 to 11 are a detail of a preferred embodiment of system sensors.

In these figures, the numeric references correspond to these parts and elements:

1. Reflective surface.

2. Mobile support.

3. Primary axis.

4. Primary drive.

5. Secondary axis.

6. Secondary drive.

7. Pedestal.

8. Control device.

9. Zenith axis.

10. Drive plane.

11. Target or solar receptor.

12. Sun.

13. Tower.

14. Sensor condition 1.

15. Sensor condition 2.

16. Ground.

17. Optical system

18. Optical axis

19. Deflected main beam

20. Reflection plane.

21. Main plane of the optics.

22. Incident main beam.

23. Reflected main beam.

24. Opaque surface

25. Sensitive surface

26. Secondary reflective surface

27. Incident secondary beam

### PREFERRED EMBODIMENT OF THE INVENTION

FIG. 1 shows a solar thermal power plant with central receiver, where there has been represented a detail of the area of the tower where the solar receiver is located.

FIG. 2 shows the standard mounting of a heliostat. Note that how the primary axis (3) is inserted into the pedestal (7), while the secondary axis (5) is “dragged” by the primary axis (3) itself.

The proposed solution lies in inclination of the primary axis so that it points to the target (11).

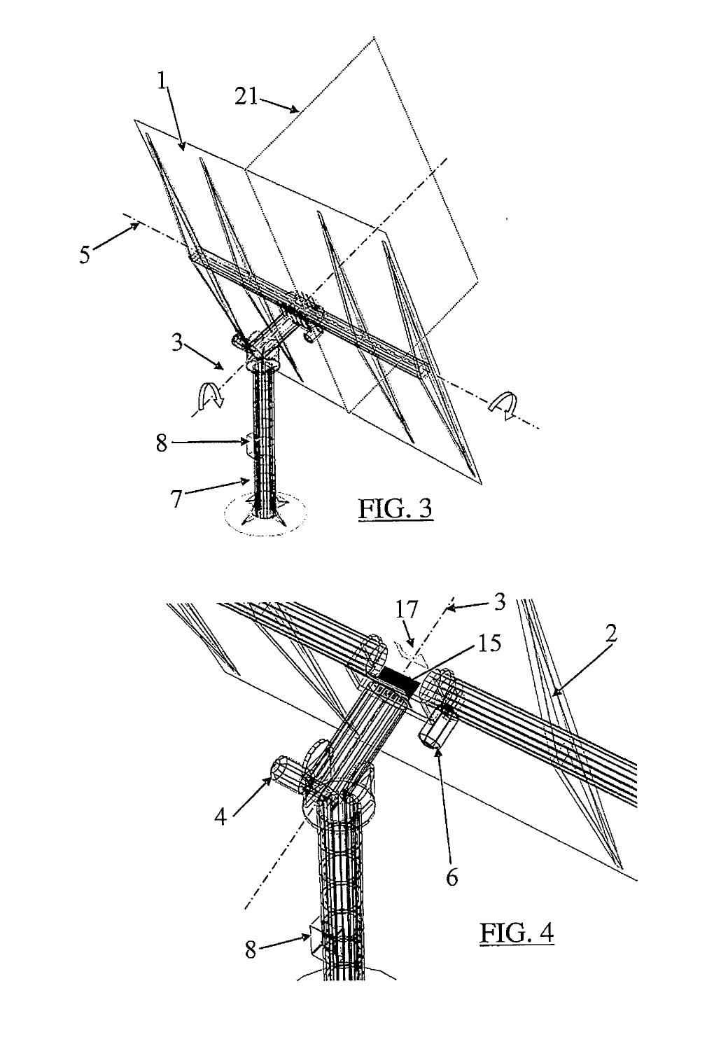

The preferred embodiment is represented in FIG. 3, where it can be seen that the system consists of a fixed structure formed by a pedestal (7) which can be made of steel or concrete, and the main axis (3), this being adjustable in elevation and horizontal orientation to point to the target (11). This adjustment is carried out for each heliostat and only once when being installed the system, since from this initial adjustment the main axis (3) remains fixed in space over time. It also consists of a reflective surface (1), which relies on a mobile support (2) that prevents the deformation of said surface and, in turns, allows the movement by which the reflection of solar energy reaches the receiver. These movements are produced by a drive system consisting of two independent drives (4) and (6), of which, in this preferred and non-limitative embodiment, the main drive (4) is a linear drive while the secondary drive is a rotary drive, both being those that allow the pointing of the heliostat. The system is completed with a set of reflection sensors (14) and (15), represented in detail in the FIGS. 9, 10, and 11, and a control device that is responsible for the energy reflected by the heliostat reaches the receiver (11) at all times.

The system bases its operation in carrying out a rotation around a fixed axis (main axis (3)) which has the peculiarity of pointing at the solar receiver or target (11).

The second rotation carried out by the heliostat in order to control the pointing of the system is done according to an axis perpendicular to the main axis called secondary axis (5).

The first condition of pointing that the system must meet is that the main plane of the optics (21) contain the incident main beam (22), or, in other words, that the main plane of the optics (21) is coincident with the reflection plane (20). In FIGS. 6 through 8 this condition is met, the plane of the drawing in the FIG. 6 being also the main plane of the optics (21). If this condition is not fulfilled, the reflected main beam would deviate with respect to the target (11).

This condition is fulfilled through the primary drive (4) arranged according to the primary axis (3).

The second condition is that the reflected main beam (23) is parallel to the primary axis (3). This condition is achieved by using the secondary drive (6) according to the secondary axis (5), and is only possible if the first condition is fulfilled.

The operation of both drives follows an independent strategy, but finally both conditions must be met.

The sensor system detects if the conditions of pointing are satisfied, or not, and if these are not fulfilled, it warns the control system to what extent or how the conditions are not met.

The system consists of two types of sensors that measure if:
The main plane of the optics (21) contains to the incident main beam (22).
The reflected main beam (23) is parallel to the primary axis (11).

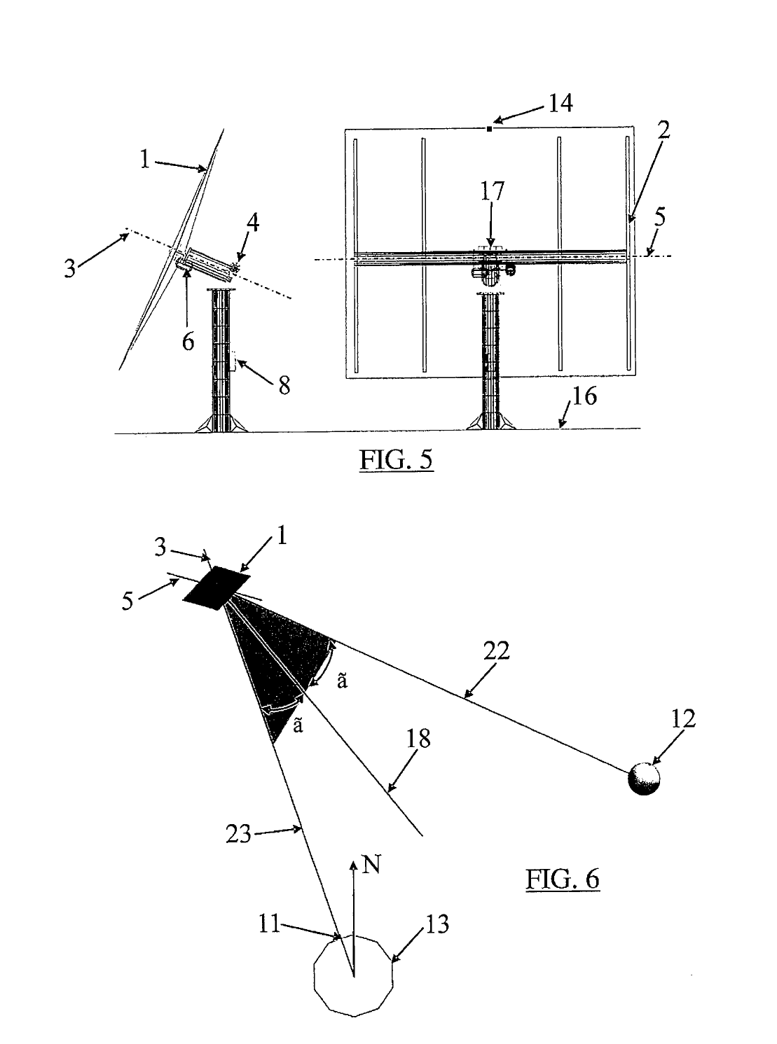

The first of the conditions is monitored by a sensor placed in the intersection of the main plane of the optics (21) and the outer edge of the reflective surface (1) and detects in which of the two spatial regions of which defined by the main plane of the optics (21) is the incident main beam. For purposes of clarity of this system, FIG. 5 clarifies the aforementioned location, and FIG. 9 shows a preferred embodiment of this sensor.

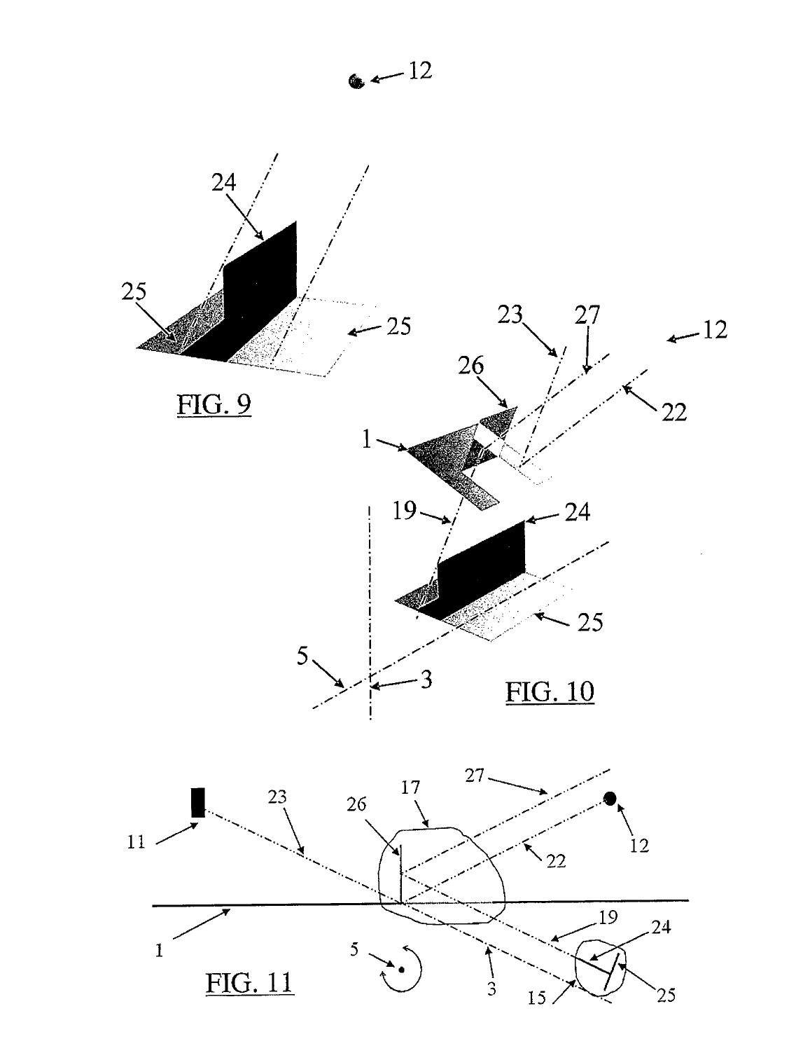

The second of the conditions is monitored by a sensor arranged according to the main axis which detects in which region of space of those defined by the drive plane (10) is the image of the Sun, after being redirected by an optical system (17) located in the preferred embodiment in the center of the reflective surface (1) and ahead of the sensor of condition 2 (15). This system is shown in FIG. 10, where the detail is extracted from the central area of the reflective surface (1). Here there is a hole through which the deflected main beam is directed to the sensor of condition 2 (15) which in this case is identical to the sensor of condition 1 (14) but with its opaque plane (24) oriented, which is its reference plane, parallel to the drive plane (10).

FIG. 5 shows a preferred embodiment from a constructive point of view, wherein there is no restriction in terms of the orientation of the target. The heliostat object of the invention includes a reflective surface (1), able to rotate through a primary drive (4) around a primary geometric axis (3) integral of a mobile support (2) which, in turn, is able to rotate around a secondary geometric axis (5) perpendicular to the primary geometric axis (3), by a secondary drive (6). Both drives (4) and (6) are governed by a control device (8). The assembly is supported by a pedestal (7) the design of which allows the movement of the reflective surface (1) and the mobile support (2) without interfering with the pedestal (7) itself.

A particular embodiment, called monopole mount and described in FIG. 3, provides the target (11) on the receiver of a tower (13), the primary axis (3) being aligned so that it crosses the target (11).

The sensor system allows determining independently the behavior of the reflection conditions expressed above, what by independent drive (both variables of control are not linked to which greatly facilitates the control of the invention) leads to the closed-loop control system to constantly meet the reflection conditions.

Mobile support structure (2) is a simple reticular structure with longitudinal sections perpendicular to the drive shaft and support which is the secondary axis (5). A detail of the preferred embodiment can be seen in FIG. 3. The secondary axis (5) is a circular cross-section beam driven by the secondary drive (6), linear drive, rotating this system around the holes in the lugs belonging to a T-shape piece, the axis of said T (the arm perpendicular to the axis formed by the centers of the lugs) being the primary axis (3). At a certain point of its length, the axis of the T will be divided into two sections, which will have relative rotation with respect to this primary axis (3)—through a union with bearings. This rotation of the primary axis (3) will be driven by the primary drive (4).

This T, in turn, is articulated according to a horizontal axis perpendicular to the primary axis (3) and at a point below the union by bearings allowing the rotation around the primary axis (3). The above-mentioned T-shape piece is articulated to allow varying the elevation of the primary axis (3) on the initial pointing, on a second T-shape piece similar to that aforementioned having two lugs and one axis (arm perpendicular to the axis formed by the lugs). In this case the axis is a single piece unlike the T-shape piece mentioned previously. The axis formed by the center of these lugs is the horizontal axis mentioned, around which the initial T-shape piece is articulated. This second T-shape piece rotates around a vertical axis with respect to the pedestal (7) to allow the azimuth orientation of the primary axis (3). Both rotations, around this vertical axis and around the lugs of the second T-shape piece, are those that allow the initial orientation of the primary axis (3) so that it always points at the target (11). These two latest rotations are prevented in the normal operation of the system being used simply for pointing at the target at the time of installation and adjustment of the system.

1. Heliostat characterized by having a drive shaft pointing at the target, two reflection or refraction solar sensors, closed-loop control system, independent of the solution provided by the main reflective optics; the first solar sensor (14) detects the position of the incident main beam (22) with respect to the main plane of the optics (21), while the second solar sensor (15) detects the position del reflected main beam (23) with respect to the drive plane (10); the closed-loop control system is retroactively supplied by the signals from these two sensors that compare said signals at all times, and coordinates de primary drive (4) and the secondary drive (6) in order to achieve the condition of pointing at the target at all times.

2. Heliostat according to claim 1, characterized by having a mobile support (2), which rotates under the action of a primary drive (4) with respect to a primary axis (3) coinciding with the direction of pointing at the target (11), and on which is mounted the reflective surface (1) of very high reflectivity which rotates under the action of a secondary drive (6) with respect to a secondary axis (5) perpendicular to both the primary axis (3) and the main plane of the optics (21).

3. Heliostat according to claim 1, characterized by having a solar sensor (14) that is preferably located in the contour of the reflective surface (1) and is integral thereto, and has an opaque surface (24) that acts as a reference plane and two sensitive surfaces (25) with respect to the incident solar energy.

4. Heliostat according to claim 1, characterized by having a solar sensor (15) that is located in the centre of the reflective surface (1) rotating solely around the primary axis (3) remaining its opaque surface (24) parallel to this shaft and to secondary axis (5) at all times; the sensor receives the solar radiation after the reflection of the same in an optical system (17), formed by a secondary reflective surface (26); this secondary reflective surface (26) is perpendicular to the reflective surface (1) of the heliostat, and contains the secondary axis thereof.
